(19) United States
(12) Patent Application Publication
(10) Pub. No.: US 2024/0352161 A1
(43) Pub. Date: Oct. 24, 2024

(54) CROSSLINKABLE POLYMER COMPOSITION, CROSSLINKED POLYMER MATERIAL, INSULATED WIRE, AND WIRING HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); KYUSHU UNIVERSITY, NATIONAL UNIVERSITY CORPORATION, Fukuoka-shi, Fukuoka (JP)

(72) Inventors: Masashi SATO, Yokkaichi-shi (JP); Takehiro HOSOKAWA, Yokkaichi-shi (JP); Yasuyuki OTSUKA, Yokkaichi-shi (JP); Tatsuya SHIMADA, Yokkaichi-shi (JP); Tatsuya HASE, Yokkaichi-shi (JP); Makoto MIZOGUCHI, Fukuoka-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); KYUSHU UNIVERSITY, NATIONAL UNIVERSITY CORPORATION, Fukuoka-shi, Fukuoka (JP)

(21) Appl. No.: 18/682,368

(22) PCT Filed: Aug. 29, 2022
(86) PCT No.: PCT/JP2022/032374

§ 371 Date: Feb. 8, 2024

(30) Foreign Application Priority Data
Aug. 30, 2021 (JP) 2021-139744

(51) Int. Cl. C08F 8/42; H01B 3/44; H01B 7/00; H01B 7/08

(52) U.S. Cl. CPC C08F 8/42; H01B 3/44; H01B 7/0045; H01B 7/0823

(57) ABSTRACT

A a crosslinkable polymer composition which provides a crosslinked product capable of both heat resistance and re-formability, a crosslinked polymer material capable of both heat resistance and re-formability, and an insulated wire and a wiring harness including the crosslinked polymer material. The crosslinkable polymer composition includes: ingredient A from which metal ion is released by heat; and ingredient B including an organic polymer having a side chain, including an electron-withdrawing substituent group capable of forming an ionic bond with the metal ion, and when B is crosslinked via the metal ion to form a crosslinked product, the product has a flow starting temperature of 190° C. or higher and 300° C. or lower. The crosslinked polymer material includes the crosslinked product of the crosslinkable polymer composition. The insulated wire includes a wire conductor, and an insulation coating including the crosslinked polymer material, and the wiring harness including the insulated wire.

### TECHNICAL FIELD

The present invention relates to a crosslinkable polymer composition, a crosslinked polymer material, an insulated wire, and a wiring harness.

### BACKGROUND ART

In an insulated wire and a wiring harness, a thermoplastic polymer composition is often used as an insulation member of an insulation coating which covers an outer periphery of a wire conductor. When the thermoplastic polymer composition is formed into a desired shape, heat is applied to be fluid and then a forming technique such as an extrusion forming is applied. In order to simplify forming by heating, a polymer composition preferably acquires fluidity without heating to an extremely high temperature.

Meanwhile, in the insulated wire and the wiring harness, temperature rise is caused by energization, and therefore, high heat resistance is required for a polymer composition such as the insulation coating placed in the vicinity of an energized site. In other words, the polymer composition is required not to cause irreversible deformation by heat generated by energization. For example, the insulation coating of the electric wire for an automobile is desired not to cause irreversible deformation at temperatures below 190° C. Especially, in the electric wire for an electric vehicle, high heat resistance is required for the polymer composition composing the insulation coating because a large current is required to be passed through the wire conductor, and the amount of heat generated when energized becomes large.

Thus, the polymer composition used for the insulated wire and the wiring harness is required to be both relatively easily formable by heating and highly heat-resistant after forming. One of a method to have both of these characteristics is to adjust the flow starting temperature of the thermoplastic polymer material to be used. However, this method has a limitation because a polymer material with a high flow starting temperature requires heating to a high temperature during forming, while a polymer material with a low flow starting temperature is unlikely to have high heat resistance. Therefore, one of methods using crosslinking of the polymer material is also employed, that is, the method is to form an uncrosslinked polymer composition into a desired shape by extrusion forming or the like, and then crosslink a molecular chain to improve heat resistance. Methods of crosslinking include electron-beam crosslinking (e.g., Patent Document 1), in which a material formed with polyolefin is irradiated with electron beams to crosslink the molecular chain of the polymer in a three-dimensional reticular formation, and silane crosslinking (e.g., Patent Document 2), in which a thermoplastic resin into which an active silane group has been introduced is formed and then crosslinked by contact with moisture or the like (e.g., Patent Literature 2). When a rubber is used as a polymer material, crosslinking by vulcanization can be used.

### PRIOR ART REFERENCES

### Patent Literature

PTL1: JP 2020-176257
PTL2: JP 2020-161398
PTL3: WO 2014/57858
PTL4: JP 7-41636
PTL5: JP 2011-162673
PTL6: JP 2010-96416
PTL7: JP 5-239292
PTL8: JP 2001-342305

### SUMMARY OF INVENTION

### Technical Problem

As described above, a polymer composition acquires high heat resistance through crosslinking by electron-beam crosslinking, silane crosslinking, or vulcanization after being formed into a desired shape, but a difficulty lies in re-forming the material into another shape after being formed into a predetermined shape. This is because crosslinking irreversibly forms a strong covalent bond, and the bond through crosslinking is effective in improving heat resistance, while a molecular chain is prevented from being re-formable by increasing fluidity again.

However, in an insulated wire and a wiring harness, re-forming is desired in some cases to the polymer material once formed into a predetermined shape. For example, due to limitation in routing space, the insulated wire may be deformed in its cross-sectional shape into a shape different from a circular cross-sectional shape, such as a flat shape, in the insulated wire with an insulation coating formed on an outer periphery of an electric wire conductor made of electric wires twisted together. Conversely, the insulated wire formed to have a cross-sectional shape different from a circular shape, such as a flat shape, may be deformed into a circular cross-sectional shape. In these cases, if the insulation coating can be re-formable by heating, the insulation coating can also be deformed by following the deformation of the electric wire conductor.

In view of the above, an object is to provide a crosslinkable polymer composition providing a crosslinked product capable of having both heat resistance and re-formability, a crosslinked polymer material capable of having both heat resistance and re-formability, and an insulated wire and a wiring harness including such a crosslinked polymer material.

### Solution to Problem

A crosslinkable polymer composition according to the present disclosure includes: ingredient A from which metal ion is released by heat; and ingredient B including an organic polymer having a side chain, wherein ingredient B includes, in the side chain, an electron-withdrawing substituent group capable of forming an ionic bond with the metal ion released from ingredient A, and when ingredient B is crosslinked via the metal ion released from ingredient A to form a crosslinked product, the crosslinked product has a flow starting temperature of 190° C. or higher and 300° C. or lower.

A crosslinked polymer material according to the present disclosure includes the crosslinked product of the crosslinkable polymer composition which is composed to crosslink ingredient B via the metal ion released from ingredient A.

An insulated wire according to the present disclosure includes: a wire conductor, and an insulation coating including the crosslinked polymer material and covering the wire conductor.

A wiring harness according to the present disclosure includes the insulated wire.

### Advantageous Effects of Invention

A crosslinkable polymer composition of the present disclosure provides a crosslinked product capable of having both heat resistance and re-formability. A crosslinked polymer material of the present disclosure can have both heat resistance and re-formability. In addition, an insulated wire and a wiring harness of the present disclosure include such a crosslinked polymer material.

### BRIEF DESCRIPTION OF DRAWINGS

FIGS. 1A to 1C illustrate a behavior of a crosslinked polymer material in one embodiment of the present invention when a crosslinked product is heated, indicating the state of higher temperatures from FIG. 1A, FIG. 1B. to FIG. 1C, in this order. M²⁺ represents a metal ion and R represents a side chain.

FIG. 2 illustrates a cross-sectional view of the structure of an insulated wire according to one embodiment of the present invention.

FIG. 3 illustrates an infrared absorption spectrum measured while heating the crosslinked polymer material.

### DESCRIPTION OF EMBODIMENTS

### Description of Embodiments of Present Disclosure

Embodiments of the present disclosure are now listed and described.

A crosslinkable polymer composition according to the present disclosure includes: ingredient A from which metal ion is released by heat; and ingredient B including an organic polymer having a side chain, wherein ingredient B includes, in the side chain, an electron-withdrawing substituent group capable of forming an ionic bond with the metal ion released from ingredient A, and when ingredient B is crosslinked via the metal ion released from ingredient A to form a crosslinked product, the crosslinked product has a flow starting temperature of 190° C. or higher and 300° C. or lower.

The crosslinkable polymer composition according to the present disclosure can crosslink ingredient B via the metal ion released from ingredient A by heating. Therefore, in an uncrosslinked composition, high formability is obtained when forming into a desired shape by extrusion forming or the like, while high heat resistance is exhibited in a polymer material by composing the crosslinked product through heating. Especially, when the flow starting temperature of the crosslinked product is 190° C. or higher, the polymer material undergone crosslinking is ensured to have high heat resistance. A highly heat-resistant material having the flow starting temperature of 190° C. or higher can be particularly suitably used for composing an insulation coating for an automotive wire.

Further, in the crosslinked product composed of the crosslinkable polymer composition of the present disclosure, a crosslinked structure is formed via the ionic bond between the substituent group and the metal ion of the organic polymer of ingredient B, and therefore, the polymer material undergone crosslinking can be re-formed by using the reversibility of the ionic bond. This is because, when the already-formed crosslinked product is heated again, a crosslinking point by the ionic bond is caused to move, thereby causing the material to have fluidity. When the substituent group introduced into the organic polymer of ingredient B is the electron-withdrawing group, the crosslinked structure is stably formed and the crosslinked product exhibits high heat resistance. Meanwhile, because the substituent group is introduced into the side chain of the organic polymer, the degree of freedom of thermal motion increases at a crosslinking site, and movement of the crosslinking point is likely to occur during heating, and therefore, excellent re-formability as well as high flexibility of the crosslinked product are exhibited. Especially, the flow starting temperature of the crosslinked product is kept 300° C. or lower, which ensures the re-formability by heating at a temperature of 300° C. or lower.

Here, ingredient B preferably has a flow starting temperature in the range of 50° C. or higher and 190° C. or lower. Then, through crosslinking by the metal ion derived from ingredient A, it is easy to obtain a crosslinked product having a flow starting temperature of 190° C. or higher and 300° C. or lower as described above. In addition, high formability can be obtained when the uncrosslinked crosslinkable polymer composition is formed into a desired shape by extrusion forming or the like.

Ingredient B preferably has a shore-D hardness lower than 50. Then, through crosslinking of ingredient B by the metal ion derived from ingredient A, it is easier to obtain a highly flexible crosslinked product which can be used for applications involving bending, such as an insulation coating of an insulated wire.

Ingredient A preferably has a decomposition or phase transition temperature at 50° C. or higher and 300° C. or lower. Then, the metal ion is suppressed from being released from ingredient A during a preparation of the crosslinkable polymer composition or prior to use of the crosslinkable polymer composition, which allows suppressing of progress of crosslinking, resulting in obtaining high storage stability in the crosslinkable polymer composition, including suppressing of quality change of the crosslinkable polymer composition at a low temperature such as room temperature. Meanwhile, ingredient A decomposes or undergoes phase transition at a moderate temperature and the metal ion is easily released from ingredient A, to thereby allow a crosslinking reaction to proceed at a temperature which does not cause quality change of ingredient B.

Ingredient A preferably has a decomposition or phase transition temperature higher than the flow starting temperature of ingredient B. Then, with ingredient B having already acquired fluidity, the metal ion is released from ingredient A and the associated crosslinking of ingredient B occurs. Therefore, ingredient A can enhance dispersibility in ingredient B by using flow of ingredient B, thereby obtaining a crosslinked product having the crosslinking point with high spatial uniformity. In addition, unintentional release of the metal ion from ingredient A and the associated progress of crosslinking of ingredient B are unlikely to occur during preparation and formation of the crosslinkable polymer composition.

Ingredient A may be a metal complex including a ligand having the structure represented by formula (1) below.

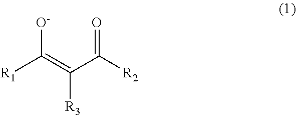

where each of R₁ and R₂ independently represents a hydrocarbon group having from 1 to 8 carbon atoms, and R₃ represents a hydrocarbon atom or a hydrocarbon group having from 1 to 8 carbon atoms, including a case where at least two of the hydrocarbon groups R₁, R₂ and R₃ are interconnected by a ring structure.

A β-diketonato ligand represented by formula (1) is a bidentate ligand which is more effective in stabilizing the metal ion than a monodentate ligand or a ligand that forms a bridging ligand coordination structure, and therefore, ingredient A is suppressed from releasing the metal ion during the preparation of the crosslinkable polymer composition and prior to use of the crosslinkable polymer composition, resulting in obtaining particularly high storage stability.

The metal ion released from ingredient A is preferably at least one selected from the group consisting of alkaline-earth, aluminum, zinc, titanium, and zirconium ions. Each of the above-mentioned metal ions has a valence of two or more and a tendency to form a stable crosslinked structure with the polymer chain of ingredient B. Furthermore, corresponding to the fact that each metal ion belongs to a hard acid in the HSAB rule and has a high ionization tendency, a stable bond is formed with the substituent group of ingredient B. For this reason, each metal is suitable for forming the crosslinked product.

The metal ion released from ingredient A may be at least one selected from the group consisting of aluminum and zirconium ions. When the metal ion is released from ingredient A, a particularly stable crosslinked structure is likely to be formed with ingredient B. In addition, high storage stability can be provided in relatively low temperature before crosslinking.

The substituent group of ingredient B may be at least one selected from the group consisting of a carboxylic acid group, an acid anhydride group, and a phosphoric acid group. Each of the substituent groups tends to form the ionic bond with the metal ion released from ingredient A. In addition, because of being an acidic group with relatively low polarity, they are less likely to cause phase separation with respect to the main and side chains of ingredient B and can form a crosslinked structure with high spatial uniformity.

The substituent group of ingredient B is preferably bonded to the main chain via an alkyl or an alkylene group having one or more carbon atoms. Then, particularly high degree of freedom of thermal motion is exhibited at the crosslinking site, and the crosslinking point is more likely to move when heating, and therefore, particularly high re-formability can be obtained.

Ingredient B is preferable not to include the electron-withdrawing group in the main chain. Then, the substituent group of the side chain is prevented from being disturbed from forming the ionic bond with the metal ion released from ingredient A due to a competition with the electron-withdrawing group in the main chain. Due to steric hindrance, the substituent group in the main chain has a difficulty in forming the stable crosslinked structure with the metal ion, and even if the crosslinked structure is formed, the degree of freedom of movement at a crosslinking portion is reduced, and high re-formability is no longer easily obtained in the crosslinked product, and flexibility is also likely to be lower.

The main chain of ingredient B preferably includes an olefin polymer or a styrene polymer. Then, the main chain is less likely to affect formation of the crosslinking point in the side chain of ingredient B and movement of the crosslinking point, and high heat resistance and re-formability brought about by those phenomena in the side chain are effectively demonstrated as properties of the entire material.

In the crosslinkable polymer composition, ingredient A may be contained in the composition in an amount of 0.1 part by mass or larger and 30 parts by mass or smaller with respect to 100 parts by mass of the sum of ingredients A and B. Then, sufficient amount of ingredient A allows an increase of a crosslinking density and makes the crosslinkable polymer composition to have an excellent crosslinking property. Meanwhile, an influence due to adding a large amount of ingredient A can be easily avoided in the material before and after crosslinking.

The crosslinked polymer material according to the present disclosure includes the crosslinked product of the crosslinkable polymer composition according to the present disclosure, wherein ingredient B is crosslinked via the metal ion released from ingredient A. Because the crosslinked product, which is formed by crosslinking of ingredient B via the metal ion released from ingredient A, has the crosslinking point at a position of the electron-withdrawing substituent group introduced into the side chain of ingredient B and the flow staring temperature in the range of 190° C. or higher and 300° C. or lower, the crosslinked polymer material becomes to have both high heat resistance and re-formability by heating. In addition, the material becomes to have high flexibility.

The insulated wire according to the present disclosure includes a wire conductor and the insulation coating covering the wire conductor. In the insulated wire, the insulation coating is composed of the crosslinked polymer material according to the above-mentioned disclosure, and therefore, high heat resistance is exhibited and irreversible deformation is unlikely to occur even if the wire conductor is heated by energization. Meanwhile, the insulation coating can be re-formed by heating to a sufficient temperature to have fluidity again, and the shape of the insulation coating can be changed. For example, when the wire conductor is deformed, the insulation coating can also be easily deformed by following the shape of the wire conductor.

Here, the wire conductor preferably includes a plurality of elemental wires twisted, and the insulated wire preferably has a flat portion in which a cross-section of the wire conductor perpendicular to an axial direction has a flat shape. The electric wire having the flat portion is demanded from a viewpoint of space saving. The flat portion is easily formed with respect to a usual insulated wire having a circular cross section, by applying a compression force to compress the insulation coating into a flat shape with the insulation coating being heated, taking advantage of the insulation coating having re-formability. Conversely, the insulated wire can be deformed to have another cross-sectional shape, such as a circular cross-sectional shape, by applying force in the direction of eliminating the flat shape to the electric wire having the flat portion, with the insulation coating being heated. Thus, by using the insulated wire including the wire conductor, having the plurality of elemental wires twisted together and being susceptible to be deformed by application of force, and the insulation coating, reversibly transitioned to be a re-formable state by heating, easier deformation is achieved bi-directionally between a low-flatness state, such as a circular cross-sectional shape, and a flat state. For example, various insulated wire can be obtained with a common insulated wire by deforming a required part into a required shape, such as a flat shape, depending on a routing part or an intended use.

A wiring harness according to the present disclosure includes the insulated wire according to the above-mentioned disclosure. As the insulated wire of the present disclosure has the insulation coating having excellent heat resistance and re-formability as described above, these properties can also be used in the wiring harness.

### Details of Embodiments of Present Disclosure

A crosslinkable polymer composition, a crosslinked polymer material, an insulated wire, and a wiring harness according to the disclosure are now described with reference to the drawings. The disclosure should not be limited to those examples.

### [1] Crosslinkable Polymer Composition and Crosslinked Polymer Material

The crosslinkable polymer composition according to the present disclosure includes: ingredient A from which metal ion is released by heat; and ingredient B including an organic polymer having a side chain, wherein ingredient B includes, in the side chain, an electron-withdrawing substituent group capable of forming an ionic bond with the metal ion released from ingredient A. In the crosslinkable polymer composition according to the present embodiment, the crosslinked polymer material according to the present embodiment is composed of a crosslinked product formed by crosslinking of ingredient B via the metal ion released from ingredient A by heating. The crosslinked product has a flow starting temperature of 190° C. or higher and 300° C. or lower.

### (1) Properties of Crosslinkable Polymer Composition and Crosslinked Polymer Material

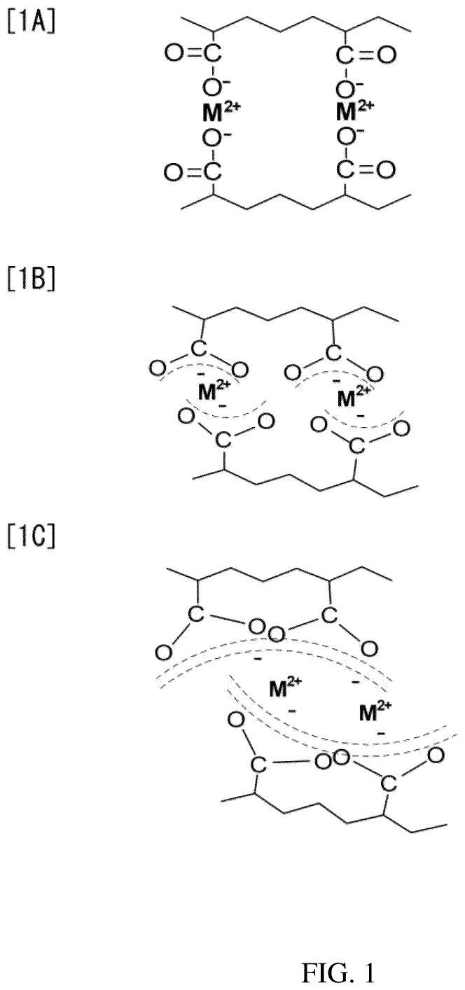

Before describing in detail of each ingredient contained in the crosslinkable polymer composition, properties of the crosslinkable polymer composition and the crosslinked polymer material will be described. The crosslinked polymer material according to the present embodiment includes ingredient A from which the metal ion is released by heat, and ingredient B including the substituent group capable of forming the ionic bond with the metal ion. In the crosslinkable polymer composition including these ingredients, the metal ion is released from ingredient A by heating. Then, as illustrated in FIG. 1A, the released metal ion forms the ionic bond with the substituent group of ingredient B, and the organic polymer chain of ingredient B is crosslinked through the ionic bond. In FIG. 1A, and FIGS. 1B to 1C illustrated later, a divalent metal ion M²⁺ is assumed as the metal ion, and a carboxylic acid group (COO—) in an anionic state is assumed as the substituent group of ingredient B. The polymer chain of ingredient B is indicated by a broken line.

Ingredient A releases the metal ion by heat, and until reaching the temperature at which ingredient A releases the metal ion by decomposition or phase transition, the metal ion is not released from ingredient A and no progress is exhibited in crosslinking of the organic polymer of ingredient B by formation of the ionic bond. Therefore, the crosslinkable polymer composition according to the present embodiment can be easily formed into a desired shape by extrusion forming or the like, when having a relatively high fluidity at a low temperature at which releasing of the metal ion from ingredient A and the associated crosslinking of ingredient B do not occur. After forming the crosslinkable polymer composition into a desired shape, ingredient A releases the metal ion by heating and ingredient B is crosslinked, and the crosslinked product is formed. The crosslinked product has improved heat resistance compared to a state before crosslinking because adjacent polymer chains of ingredient B are crosslinked. In the crosslinked product, the organic polymer chain of ingredient B is crosslinked through the ionic bond, and a bonding force is stronger than a van der Waals force, and therefore, heat resistance and mechanical strength of the crosslinked product can be effectively improved.

Especially, the crosslinkable polymer composition according to the present embodiment forms the crosslinked polymer material with high heat resistance, when the flow starting temperature of the crosslinked product to be formed is 190° C. or higher. In other words, the crosslinked polymer material formed through crosslinking is less likely to increase fluidity and cause the accompanying irreversible deformation at a temperature of 190° C. or lower. Here, heat resistance temperature of 190° C. is generally desired for an insulation coating of the insulated wire for an automobile, and the crosslinkable polymer composition according to the present embodiment can be suitably used for composing the insulation coating of the insulated wire for an automobile, as will be described in detail later. From a viewpoint of effectively increasing heat resistance of the crosslinked polymer material, the flow starting temperature of the crosslinked product is preferably 200° C. or higher, and more preferably 220° C. or higher. The flow starting temperatures of the crosslinked product and ingredient B, explained later, each refer to temperatures at which a material begins to exhibit fluidity when a solid material is heated, and can be measured as a temperature at which an indenter can penetrate a sheet material, for example, as shown in examples below. Alternatively, a melting point or a flow point of the material (or the lower one of the two, if both are present) can be considered as the flow starting temperature.

Furthermore, in the crosslinkable polymer composition of the present embodiment, a crosslinked structure with the polymer chain of ingredient B is formed by the ionic bond with the metal ion, which is a reversible bond rather than an irreversible covalent bond as formed in electron-beam crosslinking or silane crosslinking, and therefore, the formed crosslinked polymer material has re-formability. In other words, by heating the crosslinked polymer material once formed through crosslinking, the crosslinked polymer material becomes to have fluidity again, and can be formed into a different shape than before heating by applying an external force.

The re-formability of the crosslinked polymer material can be explained by the following mechanism: A crosslinking point via the metal ion is localized at a certain position in a chain of ingredient B as shown in FIG. 1A, in a state in which the crosslinked product by crosslinking of the polymer chain of ingredient B via the metal ion is not heated and kept at or near room temperature. However, when the crosslinked product is heated, molecular motion of ingredient B becomes active by heat, and active thermal motion occurs at and near the crosslinking site at which the ionic bond is formed by the substituent group of ingredient B and the metal ion, as shown in FIG. 1B. When the crosslinked product is heated to a higher temperature, the molecular motion of ingredient B further becomes active, and the crosslinking point via the metal ion can move to the different site (position of another substituent group) in the vicinity, resulting in delocalization of the crosslinking point. The delocalization of the crosslinking point forms a state in which multiple substituent groups in the same molecular chain of ingredient B are simultaneously coordinated to one metal ion (i.e, multidentate), as shown in FIG. 1C. This activation of thermal motion in ingredient B and the subsequent movement of the crosslinking point allow the crosslinked product to have fluidity. In these states, the crosslinked polymer material can be re-formed by appropriately applying an external force to the material. The activation of thermal movement at the crosslinking site and delocalization of the crosslinking point are reversible phenomenon, and when the re-formed crosslinked polymer material is cooled, the crosslinking point returns to a localized state, and the crosslinked product is returned to be thermally stable. By repeating heating and cooling, the crosslinked polymer material can also be repeatedly re-formed. The activation of thermal motion at the crosslinking site and delocalization of the crosslinking point by heating can be confirmed by infrared absorption spectra, for example. Typically, the activation of thermal motion at the crosslinking site appears on the spectrum as a broadened absorption peak of the substituent group forming the crosslinked structure, while the delocalization of the crosslinking point appears on the spectrum as a growth of a new peak corresponding to the multidentate.

Furthermore, in the crosslinkable polymer composition according to the present embodiment, the substituent group capable of forming the ionic bond with the metal ion is not included in the main chain but included in the side chain of a polymer in ingredient B, and therefore, the crosslinking site obtains high degree of freedom of movement when a crosslinked structure is formed via the metal ion. Therefore, in the crosslinked product, thermal motion of the crosslinking site and movement of the crosslinking point are particularly likely to occur actively. Therefore, the crosslinked polymer material shows high re-formability when heated. In addition, the crosslinked polymer material obtains high flexibility.

Especially, in the crosslinkable polymer composition according to the present embodiment, since the flow starting temperature of the crosslinked product, to be formed is suppressed to be 300° C. or lower, the crosslinked polymer material can be re-formed by heating to a temperature of 300° C. at the highest, and re-forming can be easily performed. From a viewpoint of effectively enhancing the re-formability, the flow starting temperature of the crosslinked product is preferably 280° C. or lower, and more preferably 250° C. or lower.

As described above, the crosslinkable polymer composition according to the present embodiment includes ingredient A from which the metal ion is released by heat, and ingredient B including the side chain having the substituent group capable of forming the ionic bond with the metal ion, and when ingredient B is crosslinked via the metal ion released from ingredient A to form the crosslinked product, the crosslinked product has a flow starting temperature of 190° C. or higher and 300° C. or lower, and thereby providing the crosslinked polymer material with both high heat resistance and re-formability. Therefore, by crosslinking the crosslinkable polymer composition after forming into a desired shape by extrusion forming or the like, the crosslinked polymer material with high heat resistance can be obtained, while re-formability of the crosslinked polymer material can be used by reheating. The crosslinkable polymer composition according to the present embodiment, having characteristics mentioned above, can be suitably used to compose a component such as the insulation coating of the insulated wire, which requires high heat resistance and is advantageous if having re-formability. Furthermore, as another indicator for confirming a sufficient effect of improvement of heat resistance by crosslinking, the crosslinked polymer material preferably has the flow starting temperature at least 5° C. higher, and more preferably at least 10° C. higher than a flow starting temperature of ingredient B alone.

Occurrences of the movement of the crosslinking site or the delocalization of the crosslinking point, described above as a behavior of the crosslinked product when heated, can be seen to some extent even at relatively low temperature such as room temperature. The movement of the crosslinking site and delocalization of the crosslinking point at the relatively low temperature can decrease elasticity and increase flexibility of the crosslinked polymer material. Therefore, the crosslinked polymer material according to the present embodiment can maintain high flexibility even after crosslinking, unlike a general crosslinked polymer material that is subjected to electron crosslinking or silane crosslinking. The high flexibility of the crosslinked polymer material obtained through crosslinking allows a suitable application to compose a member such as the insulation coating of the insulated wire which is subjected to frequent bending. For example, the crosslinked polymer material preferably has tensile elasticity of 30 MPa or less, or more preferably 20 MPa or less. Alternatively, it is preferable that the crosslinked polymer material has tensile elasticity not to be increased by more than 30% compared to the tensile elasticity of an uncrosslinked ingredient B, or even more than 20%.

As described above, in the crosslinkable polymer composition according to the present embodiment, it is important for the crosslinked product to have the flow starting temperature in a predetermined range in order to obtain the crosslinked polymer material with both heat resistance and re-formability. The flow starting temperature of the crosslinked product is determined depending on a type of the metal ion released from ingredient A, a type or a structure of the polymer main chain and the side chain, and the substituent group of ingredient B, and a ratio of ingredients A and B. A preferred structure and characteristics of each ingredient will be described below sequentially.

### (2) Ingredient A

Ingredient A is an ingredient from which the metal ion is released by heat. The term “by heat” refers to as “heating,” assuming a temperature higher than room temperature. The term “the metal ion is released” refers to that the metal ion is released from ingredient A by decomposition or phase transition of ingredient A. The metal ion released from ingredient A causes crosslinking of ingredient B.

Ingredient A preferably has the decomposition or phase transition temperature of 50° C. or higher. Then, during preparation of the crosslinkable polymer composition or prior to use of the crosslinkable polymer composition (i.e., before crosslinking), the metal ion is suppressed from being released from ingredient A and ingredient B is suppressed from progressing crosslinking, and therefore, the crosslinkable polymer composition becomes to have excellent storage stability. In other words, quality deterioration of the crosslinkable polymer composition is less likely to occur due to unintended release of the metal ion from ingredient A and the associated crosslinking of ingredient B, when the crosslinkable polymer composition is prepared by mixing ingredients A and B at a low temperature such as below 50° C., when the thus-prepared crosslinkable polymer composition is stored, or when the crosslinkable polymer composition is formed into a desired shape by extrusion forming or the like. If ingredient A has the decomposition or phase transition temperature of 60° C. or higher or even 70° C. or higher, the effect of improved storage stability is further enhanced.

Meanwhile, ingredient A preferably has the decomposition or phase transition temperature of 300° C. or lower. Then, ingredient B is less likely to be deteriorated at a temperature lower than that at which the metal ion is released from ingredient A, and therefore, undeteriorated ingredient B can be easily crosslinked via the metal ion. In addition, when ingredient A undergoes decomposition or phase transition at a moderate temperature, releasing of the metal ion from ingredient A is facilitated, and therefore, the crosslinkable polymer composition becomes to have an excellent crosslinking speed. From these viewpoints, ingredient A preferably has the decomposition or phase transition temperature of 200° C. or lower, or more preferably 150° C. or lower, or 120° C. or lower.

Further, ingredient A preferably has the decomposition or phase transition temperature higher than the flow starting temperature of ingredient B described later. Then, crosslinking of ingredient B can be progressed via the metal ion released from ingredient A at the temperature at which ingredient A releases the metal ion, with ingredient B having acquired fluidity. For this reason, crosslinking can be progressed by using the flow of ingredient B with the metal ion well-dispersed in ingredient B, to thereby easily obtain the crosslinked polymer material with highly uniform structure in which the crosslinking point by the metal ion is spatially distributed with a high degree of uniformity. In addition, unintentional release of the metal ion from ingredient A and resulting progress of crosslinking of ingredient B are unlikely to occur during preparation or formation of the crosslinkable polymer composition. More preferably, ingredient A has the decomposition or phase transition temperature higher than the flow starting temperature of ingredient B, and further preferably, ingredient A has the decomposition or phase transition temperature at least 10° C. higher than the flow starting temperature of ingredient B. The decomposition or phase transition temperature of ingredient A is expressed as a temperature at which a baseline change starts in differential scanning calorimetry (DSC) (measurement temperature range: 25° C. to 200° C., measurement in air). The above-mentioned phase transition point does not include a melting point, and the above-mentioned phase transition does not include melting. If ingredient A has both the phase transition point and the decomposition point, or a plurality of phase transition points, the lower (the lowest) one is to be treated as “the decomposition or phase transition temperature.”

A metal type of the metal ion released from ingredient A is not limited, but alkaline-earth, aluminum, zinc, titanium, zirconium can be preferably used. Preferably, the metal ion released from ingredient A may be at least one of these metals. The ion of each metal is more than divalent, and a stable crosslinked structure can be easily formed with the polymer chain of ingredient B by forming the ionic bond with the substituent group of ingredient B. In addition, each of the metals listed above belongs to a hard acid in the HSAB principle and has a relatively high ionization tendency, which indicates that each metal is suitable as a metal for composing the crosslinked product by forming a stable bond with the substituent group in ingredient B.

Among the metal types mentioned above, aluminum and zirconium are particularly suitable as metals for forming the crosslinked product. Therefore, the metal ion released from ingredient A is preferably at least one selected from the group consisting of aluminum or zirconium ions. Ingredient A including aluminum or zirconium has a certain degree of high stability, and, when mixed with ingredient B, formation of the crosslinked structure does not easily proceed, and therefore, high storage stability is provided in the crosslinkable polymer composition. Meanwhile, when ingredient A is heated, the metal ion is relatively easily released, and the crosslinked product is formed. For example, as described in an embodiment described later, a phase transition starting temperature of zirconium (IV) acetylacetonate (Zr-AA) is 180° C., which is higher among various acetylacetonate complexes. Meanwhile, for aluminum(III) acetylacetonate, the phase transition starting temperature (baseline-change starting temperature measured by DSC) is 112° C., which is not so high, but this compound has a characteristic of exhibiting a gradual change in calorific value from starting of the phase transition, and a remarkable change in calorific value occurs at around 170° C. In other words, the phase transition progresses remarkably at a relatively high temperature near 170° C.

Furthermore, when at least one of aluminum and zirconium ions is used as the metal ion released from ingredient A, the flow starting temperature of the crosslinked product is higher than when titanium is used, for example, and therefore the crosslinked polymer material becomes to have excellent heat resistance. Aluminum and zirconium do not oxidize as easily as titanium, and therefore, the presence of an oxidation pathway is less likely to reduce an efficiency of the crosslinking reaction. Further, compared to alkaline-earth such as calcium, aluminum and zirconium are not as hard as alkaline-earth as acid and are readily dispersed in ingredient B with high uniformity. In addition, compared to zinc, aluminum and zirconium tend to allow ingredient A in the form of the metal complex to have higher decomposition temperature, and thus provide higher storage stability.

Further, when a member in contact with a metal member is composed of the crosslinkable polymer composition of the present embodiment, and if the metal type contained in the crosslinkable polymer composition is the same as the main component of the metal member, an influence due to presence of the metal member tends to be minimized in formation as well as stability of the crosslinked structure at an interface between the metal member and the polymer material. For example, in the insulated wire, when the crosslinkable polymer composition according to the present embodiment is used to form the insulation coating covering the wire conductor composed of aluminum or aluminum alloy, the metal ion released from ingredient A should be aluminum.

While not limited to aluminum and zirconium and other metal types listed above as preferred ones, ion of any metal may be applied as the ion released from ingredient A as long as crosslinking ingredient B by forming the ionic bond with the substituent group of ingredient B and the crosslinked product has the flow starting temperature of 190° C. or higher and 300° C. or lower. However, a transition metal such as iron, nickel, and copper tends to provide the crosslinked product having the flow starting temperature higher than the above-mentioned range. This may be due to the fact that when the crosslinked product is composed of the ion of the metal such as the transition metal having a plurality of possible oxidation numbers or relatively low ionization tendency, the crosslinking point is less likely to move when heated (see FIG. 1C). In addition, the metal ion released from ingredient A may be not only a monoatomic metal ion but also a polyatomic ion (metal-containing ion) composed of a metal atom bonded to other atoms. However, from a viewpoint of forming a stable ionic bond with the substituent group of ingredient B, the monoatomic ion of a metal is preferable.

Ingredient A can be any chemical type as long as releasing the metal ion by heat, but the metal complex can be listed as a suitable chemical type. The metal complex is formed to have a ligand with a non-covalent electron pair coordinately bonded to a central metal ion. When the metal complex is used, excellent stabilizing effect is exhibited on the metal ion by the ligand and releasing of the metal ion from ingredient A is suppressed during the preparation of the crosslinkable polymer composition or prior to use of the crosslinkable polymer composition, and at the time of forming the crosslinkable polymer composition into a desired shape, and further the metal ion is susceptible to be released from ingredient A by heat when the crosslinkable polymer composition is crosslinked.

The ligand composing the metal complex includes a monodentate ligand having one coordination site and a multidentate ligand having two or more coordination sites. Due to a chelate effect, the metal complex with the multidentate ligand is more stable than the metal complex with the monodentate ligand or the metal complex with a ligand having a crosslinkable coordination structure represented by an alkoxide ligand. Therefore, ingredient A is preferably the metal complex with the multidentate ligand. Coordination by the multidentate ligand is more effective in stabilizing the metal ion than that by the monodentate ligand or that by a ligand having the crosslinkable coordination structure, whereby the metal ion is more effectively suppressed from being released from ingredient A during the preparation of the crosslinkable polymer composition, before using and at the time of forming the crosslinkable polymer composition.

Among the multidentate ligand, a bidentate β-diketonato ligand (1,3-diketonato ligand) can be suitably used. The β-diketonato ligand is particularly effective in stabilizing the metal ion. Because of a tendency to allow good dispersion in the organic polymer, the metal complex including the β-diketonato ligand is suitable for dispersing ingredient A in ingredient B and forming the crosslinking point with high uniformity. The β-diketonato ligand is represented by general formula (1) below:

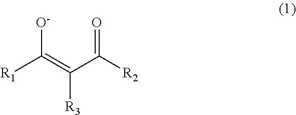

In formula (1), R₁ and R₂ each independently represents a hydrocarbon group, and R₃ represents a hydrogen atom or the hydrocarbon group, including a case where at least two of R₁, R₂, and R₃ are interconnected by a ring structure. The ligand may take the structure of formula (1) by a resonant structure.

In formula (1), each of R₁, R₂ and R₃ may be an aliphatic hydrocarbon group or a hydrocarbon group containing an aromatic ring, or may include a hetero atom such as an oxygen atom. As the hydrocarbon group composing each of R₁, R₂ and R₃, an alkyl group, an alkoxy group, an aromatic group, and a fused aromatic group may be included. The number of carbon atoms of R₁, R₂ and R₃ is not particularly limited but is preferably 1 or more to 8 or less.

Examples of the β-diketonato ligand include: an acetylacetonato ligand (acac); a 2,2,6,6-tetramethyl-3,5-heptanedionato ligand (dpm); a 3-methyl-2,4-pentadionato ligand; a 3-ethyl-2,4-pentanedionato ligand; a 3,5-heptanedionato ligand; a 2,6-dimethyl-3,5-heptanedionato ligand; and a 1,3-diphenyl-1,3-propanedionato ligand. Among these, the acetylacetonato ligand which is the hydrogen atom is particularly preferred.

Ingredient A is preferably contained in the crosslinkable polymer composition in an amount of 0.1 parts by mass or larger with respect to 100 parts by mass of the sum of ingredient A and ingredient B. Then, the presence of a sufficiently large amount of ingredient A relative to ingredient B allows the crosslinked product to have high crosslinking density, resulting in exhibiting high degree of effectiveness in improving heat resistance. From a viewpoint of increasing an improved effect of heat resistance, the content of ingredient A is more preferably 1.0 part by mass or larger, and further preferably 2.0 parts by mass with respect to the 100 parts by mass. Meanwhile, the content of ingredient A is preferably 30 parts by mass or smaller with respect to the 100 parts by mass, which tends to avoid an influence caused by the presence of a large amount of ingredient A, including separation or precipitation of ingredient A before crosslinking, and embrittlement and reduction of flexibility of the polymer material after crosslinking. From a view point of enhancing these effects, the content of ingredient A is preferably 20 parts by mass or smaller or more preferably 10 parts by mass or smaller with respect to the 100 parts by mass.

### (3) Ingredient B

Ingredient B is composed of the organic polymer having the side chain, and the side chain includes the electron-withdrawing substituent group capable of forming the ionic bond with the metal ion released from ingredient A. The substituent group does not necessarily a substituent group of the electron-withdrawing group to form the ionic bond with the metal ion released from ingredient A; however, the electron-withdrawing substituent group can form a stable ionic bond with the metal ion. Therefore, when ingredient B is crosslinked by the metal ion in the crosslinkable polymer composition, the crosslinked structure is stably formed and the crosslinked product tends to exhibit high heat resistance.

Preferable examples of the electron-withdrawing substituent groups capable of forming the ionic bond with the metal ion include any acidic group such as a carboxylic acid group, an acid anhydride group, a phosphoric acid group, and a sulfonic acid group, except hydroxyl groups. The substituent group may be only one or at least two of the above-listed substituent groups, but the substituent group is preferably at least one of the above-listed substituent groups. Especially, the acid anhydride group such as a maleic anhydride group can be suitably employed. The substituent groups listed above are excellent in readily forming the ionic bond with the metal ion released from ingredient A. Further, since each of the above-listed substituent groups is the acidic group with relatively low polarity, phase separation is less likely to occur with respect to the main and side chains of ingredient B, and the crosslinked structure can be formed in an organization of ingredient B with high uniformity. Although a sulfonic acid group, for example, is also the electron-withdrawing substituent group which tends to easily form the ionic bond with the metal ion, it is not as good as those listed above as suitable ones for the substituent group of ingredient B because phase separation is likely to occur due to high polarity.

In ingredient B, as described above, the substituent group forming the ionic bond with the metal ion is included not in the polymer main chain but in the side chain, and therefore, the crosslinking site maintains a high degree of freedom of movement when the crosslinked structure is formed. As a result, the polymer material after crosslinking obtains high re-formability with excellent flexibility. From a viewpoint of enhancing these effects, the side chain preferably has a structure and a length which allows bonding the substituent group to the main chain via the alkyl or the alkylene group having from 1 or more carbon atoms, although not particularly limited. Alternatively, the side chain may be the one which bonds the substituent group to the main chain via the hetero atom such as the oxygen atom. The substituent group may be introduced into an end of the side chain or in the middle, but preferably introduced into the end from a viewpoint of effectively increasing the degree of freedom of movement at the crosslinking site. Although no particular upper limit is set in the number of the carbon atom in the side chain, the number of the carbon atom connecting between the main chain and the substituent group is preferably 4 or less from a viewpoint of minimizing the effect on the physical properties of the main chain. When the substituent group is the carboxylic acid group and the phosphoric acid group, particularly preferred structures of the side chain portions are represented by formulae (2) and (3) below, respectively:

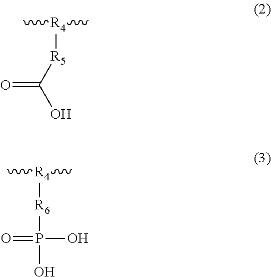

Here, R₄ represents the main chain, R₅ represents the oxygen atom, or the alkyl or alkylene group having one or more carbon atoms, and R₆ represents the alkyl or alkylene group having one or more carbon atoms. A plurality of electron-withdrawing substituent groups may be bonded to the main chain via a common R₅ or R₆. In addition, the plurality of electron-withdrawing substituent groups may form anhydride with each other.

In ingredient B, the electron-withdrawing substituent group may be or may not be included in the main chain, as long as being included in the side chain. However, the electron-withdrawing substituent group is preferably not to be included in the main chain. This is because the presence of the electron-withdrawing group in the main chain may prevent the electron-withdrawing group in the side chain from forming the crosslinked structure through the ionic bond with the metal ion. The electron-withdrawing group in the main chain is susceptible to significant steric hindrance and less likely to effectively contribute to crosslinking by the formation of the ionic bond with the metal ion, resulting in exhibiting poor effect in improving heat resistance through crosslinking. Further, even when the crosslinked structure is formed at a portion of the electron-withdrawing group in the main chain, the degree of freedom of movement is reduced at the crosslinking site, and thereby making it difficult to achieve high re-formability and flexibility. Electron-withdrawing groups preferably absent from the main chain of ingredient B include a carbonyl group having the main chain composed of a copolymer of (meth) acrylic acid, a hydrolysis group having the main chain including an ester structure such as vinyl acetate, and halogen atoms.

Although not particularly limited, the content of the substituent group in ingredient B is preferably 0.01% by mass or larger and 10% by mass or smaller with respect to the total mass of ingredient B from a viewpoint of ensuring physical properties by crosslinking. The content is more preferably 0.1% by mass or larger and 5% by mass or smaller and further preferably 0.2% by mass or larger and 3% by mass or smaller. The content of the substituent group in ingredient B can be determined by comparison of the intensity of a peak specific to the substituent group in the infrared spectrum with a material containing a known amount of the substituent group.

The organic polymer of ingredient B is a polymerized organic material such as a resin, a rubber, and an elastomer. Preferably, ingredient B is composed of a resin or elastomer having thermoplasticity. The main chain of ingredient B is preferably composed in the form of an olefin polymer. The olefin polymer may be a monopolyer such as polyethylene or polypropylene or a copolymer such as ethylene-alpha olefin copolymer. Alternatively, the main chain of ingredient B may also be preferably composed in the form of a styrene polymer such as hydrogenated styrene thermoplastic elastomer (SEBS). Other organic polymers applicable as ingredient B include elastomers having polyurethane, polyester, and polyamide main chains. The main chains having these structures are less likely to influence the formation of the crosslinking point in the side chain, the activation of molecular motion, and the movement of the crosslinking point at the crosslinking site caused by heating, and therefore, high heat resistance and re-formability as well as flexibility brought about by these phenomena in the side chain are effectively exhibited as the overall properties of the crosslinked product in ingredient B. These effects are sufficiently exhibited when the main chain of ingredient B is composed of olefin polymer.

Ingredient B preferably has a flow starting temperature in the range of 50° C. or higher and 190° C. or lower, which allows, through crosslinking via the metal ion released from ingredient A, easily providing the crosslinked product having the flow starting temperature of 190° C. or higher and 300° C. or lower. In addition, high formability can be obtained when the uncrosslinked crosslinkable polymer composition is formed into a desired shape with an extrusion forming or the like. The flow starting temperature of ingredient B is more preferably 80° C. or higher and 160° C. or lower.

Furthermore, hardness of ingredient B is preferably kept low from a viewpoint of obtaining the crosslinked product with high flexibility through crosslinking by the metal ion released from ingredient A. For example, ingredient B preferably has the shore-D hardness lower than 50, the shore-D hardness measured in accordance with JIS K6253. Then, the crosslinked polymer material including the crosslinked product can be suitably used to compose a member which requires bending, such as the insulation coating of the insulated wire. Even more preferably, ingredient B has the shore-D hardness lower than 45 or lower than 40. A lower limit of the shore-D hardness of ingredient B, although not set, is preferably 10 or higher and even preferably 20 or higher from a viewpoint of securing material strength.

The crosslinkable polymer composition according to the present embodiment may include additives such as flame retardants, copper damage inhibitors, antioxidants, and colorants as appropriate in addition to the above-described ingredients A and B. Further, although a polymer other than ingredient B may be included as a polymer component, a content of the polymer is preferably kept lower than ingredient B. Even more preferably, the crosslinkable polymer composition preferably includes only ingredient B as the polymer component. In addition, compounds of the following groups (a) to (f) are preferably absent from the crosslinkable polymer composition as an ingredient, that is, (a) silane coupling agents, (b) epoxy compounds, (c) isocyanate and isothiocyanate compounds, (d) photo-radical and thermal-radical generators, (e) chlorine and bromine compounds, and (f) volatile organic solvents are preferable not to be contained in the crosslinkable polymer composition as an ingredient. If the compounds of the groups (a) to (d) are contained in the crosslinkable polymer composition, a possibility arises in occurrence of unintended chemical reactions, such as crosslinking of ingredient B due to a reaction other than the crosslinking reaction via the metal ion released from ingredient A when heated, or cleavage of the main chain of ingredient B. Then, heat resistance and re-formability of the crosslinkable polymer composition may not be sufficiently exhibited. Further, if the compounds of group (e) are contained in the crosslinkable polymer composition, coloration or generation of corrosive gases may occur upon heating. If the compounds of group (f) are contained in the crosslinkable polymer composition, ignition or generation of bubbles may occur when forming a composition.

The crosslinkable polymer composition can be prepared by mixing ingredients A and B, and an additive added as needed. The mixing can be done by heating and kneading each ingredient, or by dissolving each ingredient in an organic solvent and heating and stirring, for example. Further, the crosslinkable polymer composition may be appropriately heated then formed into any shape by extrusion forming, when using. In this case, the heating temperature is preferably higher than the flow starting temperature of ingredient B and is lower than the temperature at which ingredient A releases the metal ion by decomposition or phase transition. In addition, when the crosslinkable polymer composition after forming is heated to a temperature higher than the temperature at which ingredient A releases the metal ion by decomposition or phase transition, crosslinking of ingredient B is progressed via the metal ion released from ingredient A, resulting in formation of the crosslinked polymer material including the crosslinked product. Then, by heating the thus-formed crosslinked polymer material to a temperature higher than the flow starting temperature of the crosslinked product, the crosslinked polymer material acquires fluidity and becomes re-formable. Re-forming can be repeated reversely. Since the crosslinkable polymer composition according to the present embodiment can form the crosslinked structure only by heating, a crosslinking process can be carried out with simple facilities than when the electron-beam crosslinking or the silane crosslinking is employed. A re-forming process can also be carried out by applying an appropriate external force while heating, similarly with simple facilities.

### [2] Insulated Wire and Wiring Harness

The crosslinked polymer material formed by the crosslinkable polymer composition according to the present embodiment can be applied for use in composing any member. However, by taking advantages of high heat resistance, re-formability and flexibility, it is suitable for use as a material for composing the insulated wire and the wiring harness for an automobile. In the insulated wire and the wiring harness, heat is easily generated by energizing the metal member including the wire conductor, and therefore, the polymer material located near the metal member is also required to have high heat resistance such that no irreversible deformation occurs when heat is generated. In addition, in some cases, re-forming of the polymer material once formed into a predetermined shape can be required due to the deformation of the insulated wire or a request for change in a structure of the wiring harness.

In the insulated wire and the wiring harness, the crosslinked polymer material according to the present embodiment can be applied to the insulation coating covering the outer periphery of the wire conductor of the insulated wire, an exterior material which binds a plurality of insulated wires in the wiring harness, and a wire protection material, although an applicable part is not specifically limited. Among these, the insulation coating of the insulated wire is preferably composed of the crosslinked polymer material according to the present embodiment.

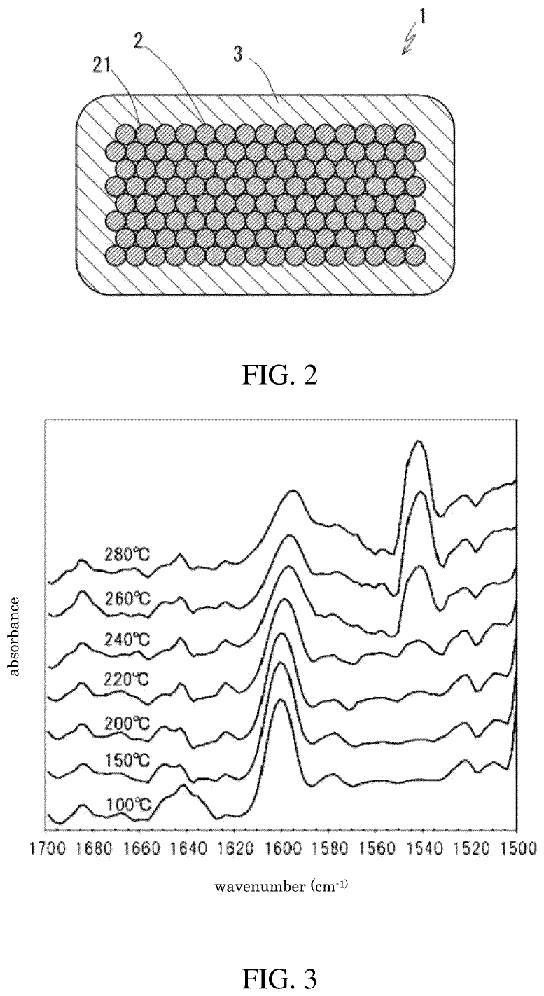

FIG. 2 illustrates an example of the insulated wire according to an embodiment of the present disclosure in a cross section perpendicular to an axial direction. An insulated wire 1 illustrated in FIG. 2 has a wire conductor 2 and an insulation coating 3 covering an outer periphery of the electric wire conductor 2. The wire conductor 2, although not particularly limited in configuration, is made as a twisted conductor in which a plurality of elemental wires 21 is twisted together. In addition, in the illustrated example, the insulated wire 1 is composed to have a flat portion, and the cross-section of the wire conductor 2 has a flat shape (i.e., a long shape in the width direction). The insulation coating 3 is composed of the crosslinked polymer material according to the embodiment of the present disclosure described above. The insulation coating 3 also has a flat cross-sectional outer shape by following the shape of the wire conductor 2.

In the insulated wire 1, heat is generated upon energizing the wire conductor 2, and the insulation coating 3 is also heated; however, the insulation coating 3 is composed of the crosslinked polymer material according to the present embodiment described above and has high heat resistance. Therefore, even if the insulation coating 3 is heated at a temperature of 190° C. or lower, for example, thermal effects such as the irreversible deformation are unlikely to occur.

Due to having the flat portion, the insulated wire 1 can improve a space-saving property by reducing a space required for wiring. Here, by taking advantage of re-formability of the crosslinked polymer material composing the insulation covering 3, the insulated wire 1 having the flat portion can be readily formed using a conventional insulated wire having a circular cross section (i.e., a round electric wire). For example, the flat portion can be readily formed by applying a compression force in one direction to the round electric wire including the insulated covering 3 composed of the crosslinked polymer material according to an embodiment of the present disclosure, with heating at a temperature higher than the flow starting temperature of the crosslinked product. This is because of the fact that the wire conductor 2 is in the form of the twisted conductor which is easily deformed by applying force, and that the insulation covering 3 is made to be fluid by heat, which is easily deformed by following the deformation of the wire conductor 2. Thereafter, by cooling the insulation covering 3, the crosslinked product can be returned to be an original and stable state. Alternatively, the already-formed flat portion can be returned to a shape of the round electric wire or a lower-flatness shape close to the shape of the round electric wire by applying force from both sides in the width direction to compress the insulation coating 3, while heating the insulation coating 3 at a temperature higher than the flow starting temperature of the crosslinked product. Again in this case, the insulation coating 3 is to be deformed into a lower-flatness shape by following the deformation of the wire conductor 2.

As descried above, because the insulation coating 3 is composed of the material having reversible re-formability, the insulated wire 1 can be easily deformed into any shape in both directions between the flat cross-sectional shape and a circular cross-sectional shape, while deforming the insulation coating 3 by following the wire conductor 2. For example, a cross-sectional shape of the insulated wire can be changed with a high degree of freedom, by forming the flat portion on the round electric wire only at a portion where a space-saving property is required in a routing path. This allows producing a variety of insulated wires having the flat portion at different locations, by using a common electric wire as a raw material, for example. The insulated wire can be used alone or in a form of the wiring harness including the insulated wire, by connecting a member such as a connection terminal or binding the insulated wire with another insulated wire.

### Example

An example is now described. The present invention is not limited by the example. Unless otherwise specified, samples were prepared and evaluated at room temperature in air.

### <Sample Preparation>

To prepare samples A1 to A10 and B1 to B13 respectively, ingredients A and B were put into xylene in an amount of five times as much as the total weight of ingredients A and B with compositions mentioned in Tables 1 and 2 (unit is in parts by mass) and stirred vigorously at 80° C. for 30 minutes to perform a dispersive mixing. The mixture was then vacuum-dried and pressed at 250° C. for 10 minutes to prepare a 2 mm thick sample sheets. By heating to 250° C., crosslinking of ingredient B occurred via a metal ion derived from ingredient A in at least samples A1 to A10. The progress of crosslinking was confirmed by infrared absorption spectrum. Specifically, absorptions of a C═O stretching vibration of acid anhydride (around 1790 cm⁻¹) and a C═O stretching vibration of carboxylic acid (around 1720 cm⁻¹), present in the infrared absorption spectrum of ingredient B before crosslinking, were confirmed to disappear or decrease with crosslinking.

The following materials were used:

### (1) Ingredient A

A decomposition or phase transition temperature obtained from DSC measurement was shown below in parentheses, along with a material type:
Ca-AA: Calcium (II) acetylacetonate (110° C.)
Zn-AA: Zinc (II) acetylacetonate (105° C.)
Al-AA: Aluminum (III) acetylacetonate (112° C.)
Zr-AA: Zirconium (IV) acetylacetonate (180° C.)
Ti-AA: Titanium (IV) acetylacetonate (125° C.)
TiO-AA: Titanium (IV) oxyacetylacetonate (158° C.)
Cu-AA: Copper (II) acetylacetonate (205° C.)
Ni-AA: Nickel (II) acetylacetonate (200° C.)
Li-AA: Lithium acetylacetonate (225° C.)
ZnO: Zinc oxide (II) (None (>300° C.))
Calcium stCa: Calcium stearate (93° C.)

### (2) Ingredient B

A flow starting temperature (measurement method is the same as that described in the section of Evaluation Methods below) and hardness (shore-D hardness measured in accordance with JIS K6253) are shown below, along with a material type:
MAH-SEBS: Maleic acid modified hydrogenated styrene thermoplastic elastomer, “M1911,” manufactured by Asahi Kasei, flow starting temperature 142° C., D-hardness 36
MAH-EO: Maleic acid modified ethylene-alpha olefin copolymer, “MH5020,” manufactured by Mitsui Chemicals, Inc, flow starting temperature 132° C., D-hardness 15
MAHA-SBBS: Maleic acid and amine modified hydrogenated styrene elastomer, “N502,” manufactured by Asahi Kasei, flow starting temperature 182° C., D-hardness 41
EMA: Ethylene-methacrylic acid copolymer, “N1110H,” manufactured by Mitsui Dow Polychemicals, flow starting temperature 109° C., D-hardness 49
SEBS: Hydrogenated styrene thermoplastic elastomer, “H1041,” manufactured by Asahi Kasei, flow starting temperature 137° C., D-hardness 36

### <Evaluation Methods>

### (1) Flow Starting Temperature

A 10 mm×10 mm×2 mm thick test specimen was prepared using the sample sheet. The specimen was placed on a hot plate with a variable temperature, and a 2 mmφ cylindrical indenter with a dial gauge attached to the top was pressed against the center of the specimen with a force of 1N. Then a distance in which the indenter entered into the sample was recorded, while the temperature of the hot plate was increased at a rate of a 5° C./min.

The flow starting temperature is defined as a temperature at which the indenter penetration reached 2.0 mm (when penetrated). If the flow starting temperature of a sample becomes at least 5° C. higher than that of ingredient B which does not include ingredient A, the sample can be regarded as being obtained an improved heat resistance through crosslinking by a metal ion.

### (2) Elastic Ratio

The above sample sheet was cut into a strip of 50 mm long×5 mm wide×2 mm thick and a tensile test was conducted at room temperature in air at a speed of 10 mm/min with a grip width of 10 mm. An elastic ratio (tensile elasticity) was obtained by converting deformation between 1N to 2N of tensile load. If the elastic ratio is within ±30% of the value of ingredient B without including ingredient A (i.e., the measured values of samples B1 to B3, B12, and B13), an influence of crosslinking on the elastic ratio can be considered small. A rate of change of the elastic ratio is “+” in a direction that the elastic ratio increases due to the crosslinking and “−” in a direction that the elastic ratio decreases due to the crosslinking. For samples B9 and B10, no sample sheets enough to evaluate the elastic ratio were obtained due to low fluidity during press forming.

### (3) Confirmation of Change in Chemical Structure During Heating

For sample A1, a vacuum-dried product prior to press forming was extracted in the process of preparing the sample described above. Then, infrared absorption spectrometry was performed in the range of 100° C. to 260° C. by the total reflection measurement method (ATR method). A temperature increase rate was 10° C./min. From the obtained spectra, a study was made as to change in a chemical structure of a crosslinked product due to heating.

### <Result of Evaluation>

Tables 1 and 2 below show a content of each ingredient (unit: parts by mass) for samples A1 to A10 and B1 to B13 in the upper row, and the results of each evaluation in the lower row.

TABLE 1

| | | Sample No. | | | | | | | | | |
|---|---|---|---|---|---|---|---|---|---|---|---|
| | | A1 | A2 | A3 | A4 | A5 | A6 | A7 | A8 | A9 | A10 |
| Ingredient A | Ca-AA | 5.0 | | | | 5.0 | | 0.1 | 25.0 | | 5.0 |
| | Zn-AA | | 5.0 | | | | 5.0 | | | | |
| | Al-AA | | | 5.0 | | | | | | | |
| | Zr-AA | | | | 5.0 | | | | | | |
| | Ti-AA | | | | | | | | | 5.0 | |
| | TiO-AA | | | | | | | | | | |
| | Cu-AA | | | | | | | | | | |
| | Ni-AA | | | | | | | | | | |
| | Li-AA | | | | | | | | | | |
| | ZnO | | | | | | | | | | |
| | stCa | | | | | | | | | | |
| Ingredient B | MAH-SEBS (142° C.) | 95.0 | 95.0 | 95.0 | 95.0 | | | 99.9 | 75.0 | 95.0 | |
| (Softning | MAH-EO (132° C.) | | | | | 95.0 | 95.0 | | | | |
| staring | MAHA-SBBS (182° C.) | | | | | | | | | | 95.0 |
| temperature) | EMA (109° C.) | | | | | | | | | | |
| | SEBS (137° C.) | | | | | | | | | | |

| | | | | | | | | | | |
|---|---|---|---|---|---|---|---|---|---|---|
| Flow starting temperature [° C.] | 225 | 203 | 237 | 246 | 240 | 229 | 194 | 258 | 190 | 268 |
| Tensile elasticity [MPa] | 15.4 | 13.0 | 14.2 | 14.6 | 3.1 | 2.8 | 13.6 | 17.1 | 13.8 | 21.1 |
| Tensile elasticity Change ratio [%] | 16.7 | −1.5 | 7.6 | 10.6 | 19.2 | 7.7 | 3.0 | 29.5 | 4.5 | 6.6 |

TABLE 2

| | | Sample No. | | | | | | | | | | | | |
|---|---|---|---|---|---|---|---|---|---|---|---|---|---|---|
| | | B1 | B2 | B3 | B4 | B5 | B6 | B7 | B8 | B9 | B10 | B11 | B12 | B13 |
| Ingredient A | Ca-AA | | | | | | | | | | | | | |
| | Zn-AA | | | | | | 5.0 | 5.0 | | | | | | |
| | Al-AA | | | | | | | | | | | | | |
| | Zr-AA | | | | | | | | | | | | | |
| | Ti-AA | | | | | | | | | | | | | |
| | TiO-AA | | | | | | | | | | | 5.0 | | |
| | Cu-AA | | | | | | | | | 5.0 | | | | |
| | Ni-AA | | | | | | | | | | 5.0 | | | |
| | Li-AA | | | | | | | | 5.0 | | | | | |
| | ZnO | | | | 5.0 | | | | | | | | | |
| | stCa | | | | | 5.0 | | | | | | | | |
| Ingredient B | MAH-SEBS (142° C.) | 100.0 | | | 95.0 | 95.0 | | | 95.0 | 95.0 | 95.0 | 95.0 | | |
| (Softning | MAH-EO (132° C.) | | 100.0 | | | | | | | | | | | |
| staring | MAHA-SBBS (182° C.) | | | | | | | | | | | | | 100.0 |
| temperature) | EMA (109° C.) | | | 100.0 | | | | 95.0 | | | | | | |
| | SEBS (137° C.) | | | | | | 95.0 | | | | | | 100.0 | |

| Flow starting temperature [° C.] | 142 | 132 | 109 | 144 | 147 | 138 | 132 | 158 | >300 | >300 | 168 | 137 | 182 |
|---|---|---|---|---|---|---|---|---|---|---|---|---|---|
| Tensile elasticity [MPa] | 13.2 | 2.6 | 97.0 | 17.6 | 19.8 | 13.0 | 220 | 14.6 | no sheet | no sheet | 15.0 | 12.8 | 19.8 |
| | | | | | | | | | available | available | | | |
| Tensile elasticity Change ratio [%] | — | — | — | 33.3 | 50.0 | 1.6 | 126.8 | 10.6 | — | — | 13.6 | — | — |

According to Table 1, each of samples A1 to A10 includes, as raw materials, ingredient A from which the metal ion is released by heat, and ingredient B including an organic polymer and, in a side chain, an electron-withdrawing substituent group capable of forming an ionic bond with the metal ion, and the sample sheet obtained through crosslinking during press forming has a flow starting temperature of 190° C. or higher and 300° C. or lower. Each of these samples A1 to A10 has the flow starting temperature which is at least 5° C. higher than that of ingredient B, and therefore, it can be said that high heat resistance is obtained by crosslinking. Further, a forming temperature of general thermoplastic resin is around 300° C., and since each of samples A1 to A10 has the flow starting temperature of 300° C. or lower, it is said that high re-formability is obtained. In addition, the elastic ratio is kept below 30 MPa, and an increase ratio with respect to the tensile elasticity of uncrosslinked ingredient B is also less than 30%, which indicate that each sample maintains high flexibility even after crosslinking.

In contrast to the above, each of samples B1 to B3, B12 and B13 does not include ingredient A and has the flow starting temperature of 190° C. or lower, corresponding to the fact that crosslinking of ingredient B via the metal ion can not proceed. In each of samples B4 and B5, zinc oxide and calcium stearate are used, respectively, as ingredient A, rather than using a metal complex. These compounds do not release the metal ion even when heated, and therefore, they can not crosslink ingredient B. Correspondingly, the flow starting temperature of each of samples B4 and B5 is well lower than 190° C., which is almost the same as in sample B1.

In sample B6, ingredient B does not include a substituent group capable of forming the ionic bond with the metal ion, and a crosslinked structure can not be formed in ingredient B via the metal ion derived from ingredient A. Correspondingly, the flow starting temperature is well lower than 190° C., which is almost the same as in sample B1.

In sample B7, ingredient B includes a carboxylic acid group of the electron-withdrawing group in a polymer main chain but no electron-withdrawing substituent group is in the side chain. In the carboxylic acid group in the main chain, steric hindrance of the adjacent methacryloyl group prevents an effective formation of the crosslinked structure via the ionic bond with the metal ion. Correspondingly, the flow starting temperature is well lower than 190° C. In addition, even if the crosslinked structure is slightly formed, the degree of freedom of movement at a crosslinking site is considered to be low, and correspondingly high elastic ratio is exhibited.

Sample B8 also has the flow starting temperature lower than 190° C. This may be due to the fact that the metal contained in ingredient A is lithium, which is a monovalent metal which can not stably form the crosslinked structure in ingredient B. Meanwhile, samples B9 and B10 have the flow starting temperatures higher than 300° C. This may be due to the fact that samples B9 and B10 contains copper and nickel as the metals of ingredient A, which have a plurality of possible oxidation numbers and a relatively low ionization tendencies, the crosslinked product is less likely to be fluidized due to movement of the crosslinking point when heated. Further, due to the fact that the crosslinked products in these samples have low fluidity, the sample sheet which can be used to measure the elastic ratio is not produced by press forming. If the temperature during press forming is further increased, a part of ingredient B begins to decompose, resulting in significant discoloration and deterioration.

In sample B11, ingredient A is composed in the form of the metal complex, and a titanium atom is in a state of TiO(II), releasing TiO²⁺ ion by heat. Although crosslinking is occurred by the substituent group in the side chain of ingredient B through the ionic bond with the metal-containing ion, the flow starting temperature of the crosslinked product is kept 190° C. or lower corresponding to the fact that the ionic bond is not so strong. The reason for non-formation of a strong ionic bond is considered to be due to a bulky steric structure of the metal coordination state at a crosslinking portion and a low molecular aggregation density of the crosslinking portion.

Here, samples A1 to A10 are compared with each other. Samples A1 to A4 and A9 differ in type of metal contained in ingredient A. Comparing the group of these samples A1 to A4 with sample A9 including titanium in ingredient A, the flow starting temperature of sample A9 is exactly 190° C. which is lower than that of the other samples. This may be due to the fact that a titanium ion, even if released from ingredient A, is susceptible to be oxidized and fell into a low activity state, which prevents a crosslinking efficiency to be increased. Meanwhile, in calcium, zinc, aluminum, and zirconium contained in ingredient A of samples A1 to A4, respectively, the metal ion released therefrom contributes to the formation of the crosslinked structure in ingredient B with keeping a highly active state. To this end, high flow starting temperature of 190° C. or higher and even 200° C. or higher is obtained, and high heat resistance is exhibited. Further, among samples A1 to A4, samples A3 and A4, which include aluminum and zirconium in ingredient A, have a particularly high flow starting temperature of 230° C. or higher. This means that if ingredient A includes anything which releases an aluminum or zirconium ion, particularly high heat resistance is obtained in the crosslinked product. In sample A1 including calcium of alkaline earth metals in ingredient A, a slight non-uniformity is observed during kneading of ingredients A and B and this may be a reason for the flow starting temperature being not as high as that of samples A3 and A4. In addition, sample A2 including zinc in ingredient A is considered to have a lower phase transition starting temperature of ingredient A than samples A3 and A4 and this may be the reason for the flow starting temperature being not as high as that of samples A3 and A4 as described above.

In each of the pairs of samples A1, A5, and A10, and in each of the pairs of samples A2 and A6, the type of ingredient B is different. Comparing the samples in each pair, the increase in the flow starting temperature due to the crosslinking is larger in samples A5 and A6, which use ingredient B whose main chain is olefin polymer, than in samples A1, A10, and A2, which use styrene-based polymer as ingredient B. In other words, the use of ingredient B whose main chain is olefin polymer is highly effective in improving heat resistance through the formation of the crosslinked structure via the metal ion. Comparing sample A1 and sample A10, both of which use ingredient B whose main chain is styrene-based polymer, the flow starting temperature is higher in sample A10. This may be due to the fact that the MAHA-SBBS used as ingredient B is amine-modified in a small amount, and a domain within an internal salt is contained in the polymer chain.

Samples A1, A7, and A8 differ from each other in the content of ingredient A in the range of 0.1 to 30 parts by mass with respect to 100 parts by mass of the sum of ingredients A and B. In each content, although the flow starting temperature of 190° C. or higher and 300° C. or lower is obtained and the elastic ratio is kept below 30 MPa, the higher the content of ingredient A, the higher the flow starting temperature. Meanwhile, the elastic ratio is kept low as the content of ingredient A is reduced, and high flexibility is exhibited.

Finally, using sample A1 as an example, a study was made in change of the chemical structure of the crosslinked product when heated for crosslinking ingredient B via the metal ion. FIG. 3 illustrates the infrared absorption spectrum (ATR-IR spectrum) of sample A1 which was measured while increasing the temperature of the vacuum-dried product of the composition. The measurement was performed starting at 100° C., and at the temperature of 100° C., sample A1 already showed a progress of crosslinking of ingredient B via the metal ion released from ingredient A, and the peak near 1600 cm⁻¹ can be attributed to the C═O anti-symmetric stretching of the carboxylic acid group with the metal ion (i.e., calcium ion) released from ingredient A being ionic-bonded in monodentate, as shown in FIG. 1A.

The above-described peak near 1600 cm⁻¹ broadens with increasing temperature. This broadening indicates that molecular motion is activated in the vicinity of the carboxylic acid group. In other words, as shown in FIG. 1B, thermal motion is activated in the vicinity of the crosslinking site, including the side chain of ingredient B.

In addition, a new peak appears near 1540 cm⁻¹ in the spectrum when the temperature is increased into 240° C. or higher, and the peak grows with further increase of the temperature. According to previous findings, the new peak can be attributed to C═O symmetric stretching in a state in which the coordination of the carboxylic acid group to the metal ion is delocalized (multidentate) That is, as shown in FIG. 1C, delocalization of the crosslinked structure in the molecular chain of ingredient B suggests that the crosslinking point is movable. This movement of the crosslinking point is considered to cause the already-formed crosslinked product to obtain fluidity and become in the re-formable state. The fact that the appearance of the new peak occurring between 220° C. and 240° C. is also consistent with the fact that the flow starting temperature of sample A1 is 225° C., which is within the range between these temperatures, as shown in Table 1, supporting the above mechanism.

Although some embodiments of the disclosure have been described in detail hereinbefore, the present invention is not limited thereto, and various modifications can be made without departing from the gist of the invention.

### LIST OF REFERENCE SIGNS

1 Insulated wire
2 Wire conductor
21 Elemental wire
3 Insulation covering

1. A crosslinkable polymer composition, comprising:
ingredient A from which metal ion is released by heat; and
ingredient B comprising an organic polymer having a side chain,
wherein ingredient B comprises, in the side chain, an electron-withdrawing substituent group capable of forming an ionic bond with the metal ion released from ingredient A, and
when ingredient B is crosslinked via the metal ion released from ingredient A to form a crosslinked product, the crosslinked product has a flow starting temperature of 190° C. or higher and 300° C. or lower.

2. The crosslinkable polymer composition according to claim 1, wherein ingredient B has a flow starting temperature of 50° C. or higher and 190° C. or lower.

3. The crosslinkable polymer composition according to claim 1, wherein ingredient B has a shore-D hardness lower than 50.

4. The crosslinkable polymer composition according to claim 1, wherein ingredient A has a decomposition or phase transition temperature of 50° C. or higher and 300° C. or lower.

5. The crosslinkable polymer composition according to claim 1, wherein ingredient A has a decomposition or phase transition temperature higher than a flow starting temperature of ingredient B.

6. The crosslinkable polymer composition according to claim 1, wherein ingredient A is a metal complex comprising a ligand having a structure represented by formula (1) below: 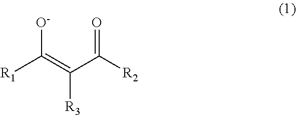
where each of R₁ and R₂ independently represents a hydrocarbon group having from 1 to 8 carbon atoms, and R₃ represents a hydrocarbon atom or a hydrocarbon group having from 1 to 8 carbon atoms, including a case where at least two of the hydrocarbon groups R₁, R₂ and R₃ are interconnected by a ring structure.

7. The crosslinkable polymer composition according to claim 1, wherein the metal ion released from ingredient A is at least one selected from the group consisting of alkaline-earth, aluminum, zinc, titanium, and zirconium ions.

8. The crosslinkable polymer composition according to claim 7, wherein the metal ion released from ingredient A is at least one selected from the group consisting of aluminum and zirconium ions.

9. The crosslinkable polymer composition according to claim 1, wherein the substituent group of ingredient B is at least one selected from the group consisting of a carboxylic acid group, an acid anhydride group, and a phosphoric acid group.

10. The crosslinkable polymer composition according to claim 1, wherein the substituent group of ingredient B is bonded to a main chain via an alkyl group or an alkylene group having a carbon number of 1 or more.

11. The crosslinkable polymer composition according to claim 1, wherein ingredient B has a main chain comprising no electron-withdrawing group therein.

12. The crosslinkable polymer composition according to claim 11, wherein the main chain of ingredient B comprises an olefin polymer or a styrene polymer.

13. The crosslinkable polymer composition according to claim 1, wherein ingredient A is contained in the composition in an amount of 1 part by mass or larger and 30 parts by mass or smaller with respect to 100 parts by mass of the sum of ingredient A and ingredient B.

14. A crosslinked polymer material comprising a crosslinked product of the crosslinkable polymer composition according to claim 1, wherein ingredient B is crosslinked via the metal ion released from ingredient A.

15. An insulated wire, comprising:
a wire conductor; and
an insulation coating comprising the crosslinked polymer material according to claim 14, covering the wire conductor.

16. The insulated wire according to claim 15, wherein the wire conductor comprising a plurality of elemental wires twisted together, and the insulated wire has a flat portion where the conductor has a flat shape in a cross-section perpendicular to an axial direction of the insulated wire.

17. A wiring harness, comprising the insulated wire according to claim 15.
